(19) United States
(12) Patent Application Publication
(10) Pub. No.: US 2026/0104615 A1
(43) Pub. Date: Apr. 16, 2026

(54) POLYMETALLIC CARBON OXIDE ION STORAGE LAYER MATERIAL FOR ELECTROCHROMIC DEVICES AND METHOD OF PREPARATION

(71) Applicant: LannRay Advanced Materials Co. LTD, Ningbo (CN)

(72) Inventors: Xiongwei WANG, Ningbo (CN); Danyang LI, Ningbo (CN); Miaozi LI, Ningbo (CN); Yan ZHOU, Ningbo (CN); Jing WANG, Ningbo (CN)

(21) Appl. No.: 19/349,261

(22) Filed: Oct. 3, 2025

(30) Foreign Application Priority Data
Oct. 14, 2024 (CN) 202411427251.8

(51) Int. Cl. G02F 1/1523; G02F 1/1503; G02F 1/1524

(52) U.S. Cl. CPC G02F 1/1525; G02F 1/1503; G02F 1/1524

(57) ABSTRACT

A method for making a multi-metal carbon oxide ion storage layer material comprises: mixing a first metal oxide precursor, a second metal or non-metal oxide precursor and a polar solvent thoroughly, and performing special aging treatment at room temperature; and then wet coating the aged solution on a conductive substrate to form a film, and then performing baking treatment to obtain the multi-metal hydrated carbon oxide ion storage layer material.

### CROSS-REFERENCE TO RELATED APPLICATIONS

This application claims priority to Chinese Patent Application No. 202411427251.8, filed with the China National Intellectual Property Administration on Oct. 14, 2024, and entitled “Polymetallic Carbon Oxide Ion Storage Layer Material for Electrochromic Devices and Method of Preparation,” which is incorporated herein by reference in its entirety.

### TECHNICAL FIELD

The present invention belongs to the technical field of inorganic metal oxide films and relates to a multi-metal carbon oxide ion storage layer material for electrochromic devices and a preparation method thereof.

### BACKGROUND

An electrochromic device is usually composed of a transparent conductive layer (ITO), an electrochromic functional layer, an electrolyte layer, an ion storage layer and a transparent conductive layer (ITO). The working principle of the ion storage layer relies on a reversible electrochemical redox reaction, which cooperates with the electrochromic layer to intercalate or de-intercalate counterions to complete reversible color change in the forward or reverse direction. During the process of counterion intercalation and deintercalation, the ion storage layer undergoes changes in terms of chemical structure and volume. Such changes have a relatively significant impact on the charge-discharge cycle stability of the material. Vanadium pentoxide (V₂O₅), as an oxide with a layered structure, is often used as an electrochromic material or an ion storage material in many reported studies. However, vanadium pentoxide has the problem of poor cycle stability. Especially at high temperature, vanadium pentoxide fails rapidly, which seriously affects the reliability of electrochromic devices. Although doping with some metal heteroatoms can improve the charge-discharge cycle stability of the material, this in turn causes a slowdown in the color switching speed. Therefore, there is a need to develop a method of making a vanadium pentoxide-based functional material with excellent charge-discharge cycle stability and color switching speed.

### SUMMARY

In order to overcome the defects and deficiencies of the prior art, the present application is directed to a multi-metal carbon oxide ion storage layer material for electrochromic devices and a preparation method therefor. When used as an ion storage layer, the multi-metal carbon oxide composition of the present application can significantly improve the charge-discharge cycle stability of vanadium pentoxide, while ensuing higher color switching speed.

To solve the above technical problem, the present application provides the following technical solutions:
In a first aspect, the present application provides a multi-metal carbon oxide ion storage layer material for electrochromic devices. The ion storage layer material is prepared by aging a multi-metal carbon oxide precursor composition, followed by wet coating, where the composition includes a first metal oxide precursor, a second metal and/or nonmetal oxide precursor, and a polar solvent.
In some embodiments, the first metal oxide precursor is a vanadium oxide precursor which includes an alkoxy vanadium oxide and/or an alkoxy vanadium;
the vanadium oxide precursor is selected from at least one of trimethoxyvanadium (V) oxide, vanadium (V) ethoxide, vanadium (V) triethoxyoxide, vanadium (V) oxidetriisopropoxide, vanadium (V) butoxide, vanadium (V) oxidetri-tert-butoxide, isopropoxyacetylacetonatovanadium (V) (V(acac)(O-iPr)₄, V(acac)₂(O-iPr)₃, V(acac)₃(O-iPr)₂, and V(acac)₄(O-iPr)), and bis(acetylacetonato) oxovanadium (IV).

In some embodiments, the second metal or nonmetal oxide precursor is selected from at least one of a titanium oxide precursor, a niobium oxide precursor, a zirconium oxide precursor and a silicon oxide precursor.

In some embodiments, the titanium oxide precursor is selected from at least one of tetrabutyl titanate, tetraethyl titanate, tetraisopropyl titanate, bis(2,4-pentanedionato) titanium (IV) oxide and bis(acetylacetonyl) diisopropyl titanate;
the niobium oxide precursor is selected from at least one of niobium isopropoxide, niobium n-propanol, niobium n-butoxide, niobium ethoxide and niobium oxalate;
the zirconium oxide precursor is selected from at least one of tetrabutyl zirconate, tetraisopropyl zirconate, tetraethyl zirconate, zirconium acetate and zirconium acetylacetonate;
the silicon oxide precursor is selected from at least one of an alkoxysilane (such as tetraethoxysilane and tetramethoxysilane), a hydroxysilane, a mercaptosilane, an epoxysilane and a fluorosilane.

In some embodiments, the polar solvent is selected from an alcoholic solvents and/or a ketones solvents.

In some other embodiments, the polar solvent is selected from at least one of ethanol, isopropanol, n-butanol, sec-butanol and butanone.

In some embodiments, the aging treatment includes: stirring the prepared composition in an uncapped container at room temperature for 2-24 h in a constant-humidity environment with a humidity of 30-75Rh % and then capping and sealing the container, and allowing the composition to stand still at room temperature for 3-14 days.

In some embodiments, the concentration of the precursors in the composition is between 1 wt % and 30 wt %.

In the present application, during the aging treatment process, the oxide precursors in the system react and condense with each other to form a nanoparticle sol.

In some embodiments, the ion storage layer material includes a multi-metal carbon oxide or a hydrate material thereof, the multi-metal carbon oxide being formed by doping one or more of titanium oxide, niobium oxide, zirconium oxide and silicon oxide with a vanadium oxide.

In some embodiments, the ion storage layer material includes a multi-metal carbon oxide hydrate material formed by doping one or more of titanium oxide, niobium oxide, zirconium oxide and silicon oxide with a vanadium oxide.

In some embodiments, the ion storage layer material includes, but is not limited to, at least one of the following multi-metal carbon oxides:
Tiₓ₁Vₓ₂O_{y}C_{z}⋅nH₂O, where a ratio of x1/x2 (molar ratio) ranges from 1:10 to 1:1;
Nbₓ₁Vₓ₂O_{y}C_{z}⋅nH₂O, where a ratio of x1/x2 ranges from 1:20 to 1:1;
Zrₓ₁Vₓ₂O_{y}C_{z}⋅nH₂O, where a ratio of x1/x2 ranges from 1:10 to 1:1;
Siₓ₁Vₓ₂O_{y}C_{z}⋅nH₂O, where a ratio of x1/x2 ranges from 1:15 to 1:2; and
Siₓ₁Tiₓ₂Vₓ₃O_{y}C_{z}⋅nH₂O, where a ratio of x1/x2 ranges from 1:15 to 1:1, and a ratio of x2/x3 ranges from 1:10 to 1:1;

In the multi-metal carbon oxides, n ranges from 0 to 3.

In some embodiments, in the multi-metal carbon oxides, n is other than 0.

In some embodiments, in the multi-metal carbon oxides, the atomic percent of tetravalent vanadium (V⁴⁺) in vanadium elements ranges from 10 at % to 70 at %. In the present application, the tetravalent vanadium may come from oxygen vacancy formation caused by heteroatom doping, or from redox reaction between a vanadium (V⁵⁺) oxide precursor and an organic solvent (an alcohol solvent and/or a ketone solvent) during the aging process.

In some embodiments, the ion storage layer material includes a coating layer with a thickness of 20 nm to 300 nm, and the ion storage layer material exists in the coating layer in the form of stacked nanoparticles with a particle size of 10 nm to 50 nm.

In a second aspect, the present application provides an electrochromic device including the ion storage layer material of the first aspect.

In a third aspect, the present application provides a preparation method for the ion storage layer material described above, including: providing a multi-metal carbon oxide precursor composition for preparing the ion storage layer material; and performing an aging treatment on the composition and then coating the aged composition on a conductive substrate to form a film, and then performing staged baking treatment to give the final multi-metal carbon oxide ion storage layer material.

In some embodiments, the conductive substrate includes a PET-ITO film, an ITO conductive glass, a PET-metal mesh or a PET-nano silver wire film.

In some embodiments, the coating for film formation includes coating for film formation by means of spin coating, screen printing, microgravure coating or slit die coating.

In some embodiments, the staged baking includes two stages of baking at a low temperature and a high temperature, where the baking at a low temperature is performed at a temperature of 30° C. to 50° C. for 1 min to 5 min, and the baking at a high temperature is performed at a temperature of 100° C. to 145° C. for 2 min to 60 min.

Compared with the prior art, the present application has the following beneficial effects:
According to the present application, a second metal or non-metal oxide precursor is doped with a vanadium oxide precursor, and after simple aging treatment and step baking, a hydrated multi-metal carbon oxide ion storage layer material with excellent performance can be obtained under the condition of properly controlling the proportion of each component. The prepared electrochromic device maintains excellent color switching speed, while achieving significantly improved charge-discharge cycle stability, as compared with those using an vanadium oxide as an ion storage layer. In addition, the preparation method of the present invention is simple, requires a low baking temperature, and can be adapted to roll-to-roll mass production via wet coating methods, thus achieving broad application prospects.

### BRIEF DESCRIPTION OF THE DRAWINGS

FIG. 1 shows the change in ion storage capacity per unit area with the number of charge-discharge cycles for electrochromic devices prepared in Examples and Comparative Examples at a high temperature of 80° C.

FIG. 2 shows color switching time (T90+ represents the bleaching time, and T90-represents the coloring time) of electrochromic devices prepared in Examples and Comparative Examples at room temperature.

FIG. 3 shows a surface SEM image of Tiₓ₁Vₓ₂O_{y}C_{z}⋅nH₂O ion storage layer material in Example 1.

FIG. 4 shows a surface SEM image of an ion storage layer material prepared from the pure vanadium oxide precursor in Comparative Example 1.

FIG. 5 shows an example of X-ray photoelectron spectrum and V4+/V5+ peaking fitting diagram of vanadium 2p of the multi-metal carbon oxide ion storage layer materials.

### DETAILED DESCRIPTION OF THE EMBODIMENTS

For ease of understanding, the invention will be described in further detail below with reference to the accompanying drawings and specific embodiments. It should be understood that these embodiments are only used to illustrate the invention but not to limit the scope of the invention.

The present disclosure also relates to electrochromic devices that include the ion storage materials described herein as primary functional layers. Other components of the electrochromic devices are generally known in the art. For example, the electrochromic devices referred to in the following examples further include electrochromic polymers recited in U.S. Pat. No. 9,975,989, which is incorporated herein by reference in its entirety. For another example, the electrochromic devices further include electrolyte layers recited in U.S. Pat. No. 10,597,518, which is incorporated herein by reference in its entirety.

### Example 1: Preparation of Tiₓ₁Vₓ₂O_{y}C_{z}⋅nH₂O Ion Storage Layer

34 g of n-butanol solvent was placed to a 100 ml sample bottle and stirred with a magnetic stirrer, and then 5.01 g of vanadium (V) butoxide and 0.99 g of tetrabutyl titanate were respectively added to the n-butanol solvent (x2/x1=6:1). At room temperature and humidity of 65Rh %, the resulting solution was stirred for 4 h in the sample bottle which was uncapped. Then, the sample bottle was capped and sealed and the solution was left to stand still and age at room temperature for 7 days to obtain an ion storage material precursor solution. The prepared solution was coated on a PET-ITO film by means of an OSP-12 wire bar at 400 mm/min, followed by baking in a 32° C. oven for 3 min to remove most of the solvent, and then in a 140° C. oven for 5 min to obtain a final Tiₓ₁Vₓ₂O_{y}C_{z}⋅nH₂O ion storage layer film. The surface microstructure of the prepared ion storage film existed, as shown in FIG. 3, in the form of 10-20 nm nanoparticles stacked on each other and partially connected. The percent of tetravalent vanadium in the prepared ion storage layer material was 37.2 at %.

### Example 2: Preparation of Nbₓ₁Vₓ₂O_{y}C_{z}⋅nH₂O Ion Storage Layer

34 g of n-butanol solvent was placed to a 100 ml sample bottle and stirred with a magnetic stirrer, and then 4.28 g of vanadium (V) butoxide and 1.72 g of niobium n-butoxide were respectively added to the n-butanol solvent (x2/x1=4:1). At room temperature and humidity of 65Rh %, the resulting solution was stirred for 4 h in the sample bottle which was uncapped. Then, the sample bottle was capped and sealed and the solution was left to stand still and age at room temperature for 10 days to obtain an ion storage material precursor solution. The prepared solution was coated on a PET-ITO film by means of an OSP-12 wire bar at 400 mm/min, followed by baking in a 32° C. oven for 3 min to remove most of the solvent, and then in a 130° C. oven for 5 min to give a final Nbₓ₁Vₓ₂O_{y}C_{z}⋅nH₂O ion storage layer film. The percent of tetravalent vanadium in the prepared ion storage layer material was 25.6 at %.

### Example 3: Preparation of Zrₓ₁Vₓ₂O_{y}C_{z}⋅nH₂O Ion Storage Layer

34 g of n-butanol solvent was placed to a 100 ml sample bottle and stirred with a magnetic stirrer, and then 4.49 g of vanadium (V) butoxide and 1.51 g of tetrabutyl zirconate were respectively added to the n-butanol solvent (x2/x1=4:1). At room temperature and humidity of 65Rh %, the resulting solution was stirred for 2 h in the sample bottle which was uncapped. Then, the sample bottle was capped and sealed and the solution was left to stand still and age at room temperature for 7 days to obtain an ion storage material precursor solution. The prepared solution was coated on a PET-ITO film by means of an OSP-12 wire bar at 400 mm/min, followed by baking in a 32° C. oven for 3 min to remove most of the solvent, and then in a 140° C. oven for 5 min to give a final Zrₓ₁Vₓ₂O_{y}C_{z}⋅nH₂O ion storage layer film. The percent of tetravalent vanadium in the prepared ion storage layer material was 41.2 at %.

### Example 4: Preparation of Siₓ₁Vₓ₂O_{y}C_{z}⋅nH₂O Ion Storage Layer

34 g of ethanol solvent was placed to a 100 ml sample bottle and stirred with a magnetic stirrer, and then 5.12 g of vanadium triethoxyoxide and 0.88 g of tetraethoxysilane were respectively added to the n-butanol solvent (x2/x1=6:1). Then, the sample bottle was capped and sealed and the solution was stirred at room temperature for 1 h to obtain an ion storage material precursor solution. The prepared solution was coated on a PET-ITO film by means of an OSP-12 wire bar at 400 mm/min, followed by baking in a 32° C. oven for 3 min to remove most of the solvent, and then in a 120° C. oven for 5 min to obtain a final Siₓ₁Vₓ₂O_{y}C_{z}⋅nH₂O Ion Storage Layer film. The percent of tetravalent vanadium in the prepared ion storage layer material was 29.8 at %.

### Example 5: Preparation of Siₓ₁Tiₓ₂Vₓ₃O_{y}C_{z}⋅nH₂O ion storage layer

34 g of n-butanol solvent was placed to a 100 ml sample bottle and stirred with a magnetic stirrer, and then 4.33 g of vanadium (V) butoxide, 1.28 g of tetrabutyl titanate and 0.39 g of tetraethoxysilane were respectively added to the n-butanol solvent (x3/x2/x1=1:2:8). At room temperature and humidity of 65Rh %, the resulting solution was stirred for 4 h in the sample bottle which was uncapped. Then, the sample bottle was capped and sealed and the solution was left to stand still and age at room temperature for 7 days to give an ion storage material precursor solution. The prepared solution was coated on a PET film with sputtered indium tin oxide (ITO) on a PET-ITO film by means of an OSP-12 wire bar at 400 mm/min, followed by baking in a 32° C. oven for 3 min to remove most of the solvent, and then in a 140° C. oven for 5 min to obtain a final Siₓ₁Tiₓ₂Vₓ₃O_{y}C_{z}⋅nH₂O ion storage layer film. The percent of tetravalent vanadium in the prepared ion storage layer material was 39.7 at %.

### Comparative Example 1: Preparation of Vanadium Oxide Ion Storage Layer

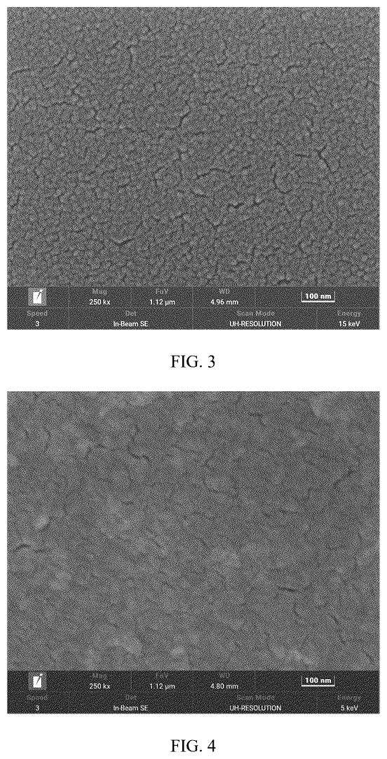

34 g of n-butanol solvent was placed to a 100 ml sample bottle and stirred with a magnetic stirrer, and then 6 g of vanadium (V) butoxide was added to the n-butanol solvent. At room temperature and humidity of 65Rh %, the resulting solution was stirred for 4 h in the sample bottle which was uncapped. Then, the sample bottle was capped and sealed and the solution was left to stand still and age at room temperature for 7 days. The prepared solution was coated on a PET film with sputtered indium tin oxide (ITO) on a PET-ITO film by means of an OSP-12 wire bar at 400 mm/min, followed by baking in a 32° C. oven for 3 min to remove most of the solvent, and then in a 140° C. oven for 5 min to obtain a final vanadium oxide ion storage layer film. The surface microstructure of the prepared ion storage film is as shown in FIG. 4. The percent of tetravalent vanadium in the prepared ion storage layer material was 7.3 at %.

### Comparative Example 2: Preparation of Tiₓ₁Vₓ₂O_{y}C_{z} Ion Storage Layer

This comparative example differs from Example 1 in that aging treatment was not performed.

34 g of n-butanol solvent was placed to a 100 ml sample bottle and stirred with a magnetic stirrer, and then 5.01 g of vanadium (V) butoxide and 0.99 g of tetrabutyl titanate were respectively added to the n-butanol solvent (x2/x1=6:1). The resulting solution was stirred for 1 h in the sample bottle that was sealed. Then, the prepared solution was coated on a PET-ITO film by means of an OSP-12 wire bar at 400 mm/min, followed by baking in a 32° C. oven for 3 min to remove most of the solvent, and then in a 140° C. oven for 5 min to provide a final Tiₓ₁Vₓ₂O_{y}C_{z} ion storage layer film. The percent of tetravalent vanadium in the prepared ion storage layer material was 13.6 at %.

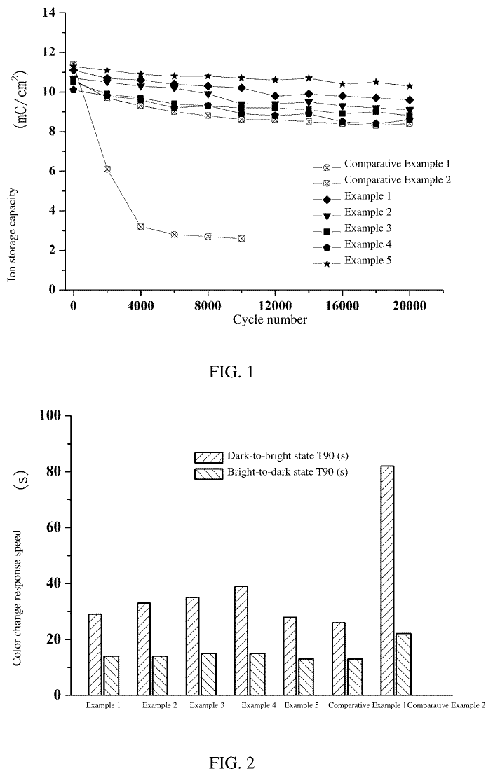

The ion storage films prepared in the above examples and comparative examples, electrochromic polymers (e.g., the electrochromic polymers recited in U.S. Pat. No. 9,975,989) and electrolytes (the electrolyte layers recited in U.S. Patent No. 10,597,518) were combined to prepare electrochromic devices. The change in ion storage capacity per unit area with the number of charge-discharge cycles, as calculated for the prepared electrochromic devices (100 mm*100 mm) under the control procedure of 80° C., +1.0 V of charge potential, −1.0V of discharge potential, and +40 s of charge time, −40 s of discharge time, is shown in FIG. 1; the color switching time is shown in FIG. 2.

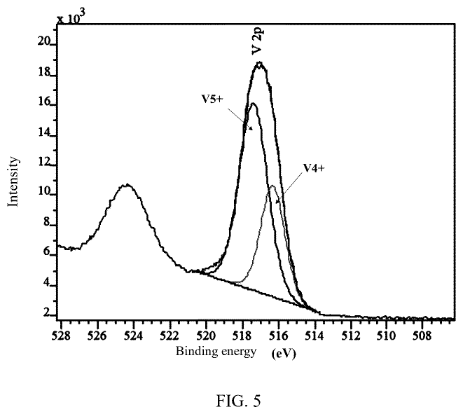

The percent of tetravalent vanadium in total vanadium elements in the ion storage materials described in the above examples and comparative examples was tested by X-ray photoelectron spectroscopy. Peak splitting and fitting were conducted on the vanadium 2p characteristic peaks. As shown in FIG. 5, the characteristic peak at ˜516.5 eV corresponds to tetravalent vanadium (V⁴⁺), and the characteristic peak at ˜517.6 eV corresponds to pentavalent vanadium (V⁵⁺). Atomic percent of V⁴⁺=integral area of V⁴⁺ characteristic peak/(total integral of area of V⁴⁺ and V⁵⁺ characteristic peaks).

From the charge-discharge stability and color switching time of the electrochromic devices corresponding to Examples 1-5 and Comparative Examples 1-2 shown in FIGS. 1 and 2, it can be seen that the process of doping a second metal or non-metal precursor (such as titanium, niobium, zirconium and silicon) with a vanadium oxide in an appropriate ratio and performing aging treatment results in a material that exhibits a comparable color switching speed to that of the pure vanadium oxide materials, while significantly improving its high-temperature charge-discharge cycle stability. In addition, the ion storage material of the present invention can be put into roll-to-roll mass production via a conventional precision coating method.

The above are only preferred embodiments of the invention and do not limit the invention in any form or essence. It should be pointed out that a person skilled in the art can make several improvements and supplements without departing from the invention, and these improvements and supplements should also be regarded as falling within the scope of the invention.

What is claimed is:

1. A multi-metal carbon oxide ion storage layer material for electrochromic devices, wherein the multi-metal carbon oxide ion storage layer material is prepared by aging a multi-metal carbon oxide precursor composition, followed by wet coating, and the multi-metal carbon oxide precursor composition comprises a first metal oxide precursor, a second metal and/or nonmetal oxide precursor, and a polar solvent.

2. The multi-metal carbon oxide ion storage layer material of claim 1, wherein the first metal oxide precursor is a vanadium oxide precursor which comprises an alkoxy vanadium oxide and/or an alkoxy vanadium;
the vanadium oxide precursor is selected from at least one of trimethoxyvanadium (V) oxide, vanadium (V) ethoxide, vanadium (V) triethoxyoxide, vanadium (V) oxidetriisopropoxide, vanadium (V) butoxide, vanadium (V) oxidetri-tert-butoxide, isopropoxyacetylacetonatovanadium (V) (V(acac)(O-iPr)₄, V(acac)₂(O-iPr)₃, V(acac)₃(O-iPr)₂, and V(acac)₄(O-iPr)), and bis(acetylacetonato) oxovanadium (IV).

3. The multi-metal carbon oxide ion storage layer material of claim 1, wherein the second metal and/or nonmetal oxide precursor is selected from at least one of a titanium oxide precursor, a niobium oxide precursor, a zirconium oxide precursor, and a silicon oxide precursor.

4. The multi-metal carbon oxide ion storage layer material of claim 3, wherein the titanium oxide precursor is selected from at least one of tetrabutyl titanate, tetraethyl titanate, tetraisopropyl titanate, bis(2,4-pentanedionato) titanium (IV) oxide, and bis(acetylacetonyl) diisopropyl titanate;
the niobium oxide precursor is selected from at least one of niobium isopropoxide, niobium n-propanol, niobium n-butoxide, niobium ethoxide, and niobium oxalate;
the zirconium oxide precursor is selected from at least one of tetrabutyl zirconate, tetraisopropyl zirconate, tetraethyl zirconate, zirconium acetate, and zirconium acetylacetonate;
the silicon oxide precursor is selected from at least one of an alkoxysilane, a hydroxysilane, a mercaptosilane, an epoxysilane, and a fluorosilane.

5. The multi-metal carbon oxide ion storage layer material of claim 4, wherein, the polar solvent is selected from at least one of ethanol, isopropanol, n-butanol, sec-butanol, and butanone.

6. The multi-metal carbon oxide ion storage layer material of claim 1, wherein the aging a multi-metal carbon oxide precursor composition comprises: stirring the prepared composition in an uncapped container at room temperature for 2-24 h in a constant-humidity environment with a humidity of 30-75Rh % and then capping and sealing the container, and allowing the composition to stand still at room temperature for 3-14 days.

7. The multi-metal carbon oxide ion storage layer material of claim 1, wherein the concentration of the precursors in the multi-metal carbon oxide precursor composition is between 1 wt % and 30 wt %.

8. The multi-metal carbon oxide ion storage layer material of claim 1, wherein the ion storage layer material comprises a multi-metal carbon oxide or a hydrate material thereof, the multi-metal carbon oxide being formed by doping one or more of titanium oxide, niobium oxide, zirconium oxide, and silicon oxide with a vanadium oxide.

9. The multi-metal carbon oxide ion storage layer material of claim 8, wherein the ion storage layer material comprises at least one of the following multi-metal carbon oxides:
Tiₓ₁Vₓ₂O_{y}C_{z}⋅nH₂O, wherein a ratio of x1/x2 (molar ratio) ranges from 1:10 to 1:1;
Nbₓ₁Vₓ₂O_{y}C_{z}⋅nH₂O, wherein a ratio of x1/x2 ranges from 1:20 to 1:1;
Zrₓ₁Vₓ₂O_{y}C_{z}⋅nH₂O, wherein a ratio of x1/x2 ranges from 1:10 to 1:1;
Siₓ₁Vₓ₂O_{y}C_{z}⋅nH₂O, wherein a ratio of x1/x2 ranges from 1:15 to 1:2; and
Siₓ₁Tiₓ₂Vₓ₃O_{y}C_{z}⋅nH₂O, wherein a ratio of x1/x2 ranges from 1:15 to 1:1, and a ratio of x2/x3 ranges from 1:10 to 1:1;
in the multi-metal carbon oxides, n ranges from 0 to 3.

10. The multi-metal carbon oxide ion storage layer material of claim 7, wherein in the multi-metal carbon oxides, the atomic percent of tetravalent vanadium (V⁴⁺) in vanadium elements ranges from 10 at % to 70 at %.

11. The multi-metal carbon oxide ion storage layer material of claim 7, comprising a coating layer with a thickness of 20 nm to 300 nm, wherein the multi-metal carbon oxide ion storage layer material exists in the coating layer in the form of stacked nanoparticles with a particle size of 10 nm to 50 nm.

12. An electrochromic device, comprising the multi-metal carbon oxide ion storage layer material of claim 1.

13. A method for preparing a multi-metal carbon oxide ion storage layer material, comprising:
providing a multi-metal carbon oxide precursor composition,
performing an aging treatment on the multi-metal carbon oxide precursor composition,
coating the aged multi-metal carbon oxide precursor composition on a conductive substrate to form a film, and
performing baking treatment on the formed film to provide the multi-metal carbon oxide ion storage layer material.

14. The method of claim 13, wherein the conductive substrate comprises a PET-ITO film, an ITO conductive glass, a PET-metal mesh, or a PET-nano silver wire film.

15. The method of claim 13, wherein the coating the aged multi-metal carbon oxide precursor composition on a conductive substrate to form a film comprises:
spin coating the aged multi-metal carbon oxide precursor composition on a conductive substrate to form a film,
screen printing the aged multi-metal carbon oxide precursor composition on a conductive substrate to form a film,
microgravure coating the aged multi-metal carbon oxide precursor composition on a conductive substrate to form a film, or
slit die coating the aged multi-metal carbon oxide precursor composition on a conductive substrate to form a film.

16. The method of claim 13, wherein the baking treatment comprises two stages of baking at a low temperature and a high temperature, wherein the baking at a low temperature is performed at a temperature of 30° C. to 50° C. for 1 min to 5 min, and the baking at a high temperature is performed at a temperature of 100° C. to 145° C. for 2 min to 60 min.

17. The method of claim 13, wherein the multi-metal carbon oxide precursor composition comprises a first metal oxide precursor, a second metal and/or nonmetal oxide precursor, and a polar solvent,
wherein the first metal oxide precursor is a vanadium oxide precursor and the second metal and/or nonmetal oxide precursor is selected from at least one of a titanium oxide precursor, a niobium oxide precursor, a zirconium oxide precursor, and a silicon oxide precursor.

18. The method of claim 17, wherein the vanadium oxide precursor is selected from at least one of trimethoxyvanadium (V) oxide, vanadium (V) ethoxide, vanadium (V) triethoxyoxide, vanadium (V) oxidetriisopropoxide, vanadium (V) butoxide, vanadium (V) oxidetri-tert-butoxide, isopropoxyacetylacetonatovanadium (V) (V(acac)(O-iPr)₄, V(acac)₂(O-iPr)₃, V(acac)₃(O-iPr)₂, and V(acac)₄(O-iPr)), and bis(acetylacetonato) oxovanadium (IV).

19. The multi-metal carbon oxide ion storage layer material of claim 17, wherein the titanium oxide precursor is selected from at least one of tetrabutyl titanate, tetraethyl titanate, tetraisopropyl titanate, bis(2,4-pentanedionato) titanium (IV) oxide, and bis(acetylacetonyl) diisopropyl titanate;
the niobium oxide precursor is selected from at least one of niobium isopropoxide, niobium n-propanol, niobium n-butoxide, niobium ethoxide, and niobium oxalate;
the zirconium oxide precursor is selected from at least one of tetrabutyl zirconate, tetraisopropyl zirconate, tetraethyl zirconate, zirconium acetate, and zirconium acetylacetonate;
the silicon oxide precursor is selected from at least one of an alkoxysilane, a hydroxysilane, a mercaptosilane, an epoxysilane, and a fluorosilane.

20. The multi-metal carbon oxide ion storage layer material of claim 17, wherein, the polar solvent is selected from at least one of ethanol, isopropanol, n-butanol, sec-butanol, and butanone.
